(19) United States
(12) Patent Application Publication
(10) Pub. No.: US 2005/0134408 A1
(43) Pub. Date: Jun. 23, 2005

(54) Circuit device and printed circuit board

(76) Inventor: Takayuki Hirabayashi, Tokyo (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/053,809

(22) Filed: Feb. 9, 2005

Related U.S. Application Data
(63) Continuation of application No. 09/641,206, filed on Aug. 18, 2000, now abandoned.

(30) Foreign Application Priority Data
Aug. 19, 1999 (JP) P11-233259

(51) Int. Cl. H01P 1/203

(52) U.S. Cl. 333/204

(57) ABSTRACT

The object of the present invention is providing cheap, minimized and thin circuit device having desired frequency characteristic. The conductive pattern, which determines the behavior of the circuit device, is formed in inside layer of the dielectric substrate 11 and the earthed conductor is formed in outside layer of the substrate 11. The conductive parts are formed on the area without the earthed conductor as the lattice-shaped pattern. If the area 15 and position of the area 15 become to variable, you have only to change the area and number of the earthed conductor 12 to change the distribution of the electromagnetic field, the circuit device can get the desired frequency characteristic.

### BACKGROUND OF THE INVENTION

1. Field of the Invention

This invention relates to a circuit device and a printed board. More particularly, the invention relates to a forming conductive pattern in inside layer in the dielectric substrate and earthed conductor in outside layer in the dielectric substrate. Moreover this invention enables the area of the earthed conductor and a position to change so that a frequency characteristic, which is set up by conductive pattern, may become desired characteristic.

2. Description of the Related Art

Recently, because of the development of the information and communication technology, mobile communication machines, ISDN and computer devices carry circuit blocks to transmit data at high speed by using the radio or some lines.

When such circuit blocks are carried on machines, not only high speed can transmit data but also it hopes for compositions in consideration of the noise. Furthermore, the miniaturization, complexation and multifunctionalizaton of parts are attempted when circuit blocks are carried on mobile devices. For example, it is unacceptable to realize low-pass filters, high-pass filters, band-pass filters and couplers with lumped parameter circuits using chip parts such as condensers and coils in high frequency applications which made a microwave band and millimeter wave band as a career like radio LAN (Local Area Network) and variety terminal of the communication devices. So low-pass filters, high -pass filters, band-pass filters and coupler using a distributed parameter circuit like a micro-strip line and strip line are used.

The coupler made to combine resonator conductive pattern of about λ/4 (λ:wave length) is being used as high-performance band-pass filters. FIG. 1 shows a coupler that has resonator conductive patterns 202 arranged in cascade-shaped on the surface of dielectric substrate 200 to combine in the surface of pattern and adjacent resonator conductive patterns have the part of the pile of the length about λ/4. However it is difficult to minimize band-pass filters because resonator conductive patterns have such as the part of the pile of the length about λ/4. Therefore resonator conductive patterns are formed on not the surface layer of the substrate but the inside layer, in other words, miniaturization is realized by the tri-plate structure. FIG. 2 shows the oblique figure of a known band-pass filter that has tri-plate structure. Earthed conductors 302 and 303 are formed on both sides of dielectric substrate (insulating substrate) 301 and resonator conductive patterns 304a and 304b are established as an annex between earthed conductor 302 and 303 to compose band-pass filters. These resonator conductive patterns 304a, 304b are established as an annex to have the pile of the length about λ/4 and one edge of pattern is short-circuited with earthed conductor 302. Moreover contacting earthed conductor 302 and earthed conductor 303 shield resonator conductive patterns 304a and 304b.

When band-pass filters are composed by using the distributed parameter circuit, shown in FIG. 3A, the pass band and the shield characteristics depend on electromagnetic field between resonator conductive pattern 401a and 401b that are formed on the dielectric substrate 400, and resonator conductive pattern 401a, 401b and earthed conductors 402 and 403. Shown in FIG. 3B, in odd exciting mode the electric field strength changes corresponding to the distance d of resonator between conductive patterns 401a and 401b. Moreover, shown in FIG. 3C, in even exciting mode the electric field strength changes corresponding to the distance of resonator conductive pattern 401a, 401b and earthed conductors 402 and 403, in other words the thickness K of dielectric substrate. The electric field strength changes corresponding to the width of resonator conductive pattern, too. In odd exciting mode and even exciting mode when the strength of the electric field changes like this, a degree of combination of resonator conductive pattern changes, and passes band characteristics change, too. Therefore when band-pass filters are designed, the thickness of the resonator conductive pattern and dielectric substrate is decided to obtain desired characteristics.

However when the thickness of resonator conductive pattern and dielectric substrate is designed to obtain desired characteristics, sometimes we cannot obtain desired characteristics because of dispersions during the manufacture process. In such a case characteristics are prepared by conducting additional process of changing the position and area of resonator conductive pattern. In the band-pass filter having tri-plate structure, resonator conductive pattern arranged between earthed conductors so it is impossible to reprocess resonator conductive pattern. Therefore it requires controlling strictly the size of resonator conductive pattern, the thickness of dielectric substrate and dielectric constant so it causes the decline of yield and cost up.

### SUMMARY OF THE INVENTION

This invention provides circuit devices and printed boards, which have desired frequency characteristics with miniaturization and thinning and without introducing cost-up.

This circuit device, having the conductive pattern which is formed in inside layer of dielectric substrate and the earthed conductor is formed in outside layer on said dielectric substrate, and the frequency characteristic is set up by said conductive pattern, provides desired frequency characteristic by changing the area and position of the earthed conductor.

The printed board has the conductor pattern that is formed in inside layer of first area in dielectric substrate and the earthed conductor which is formed in outside of first area in dielectric substrate. Moreover the frequency characteristic is set up by the conductive pattern. The printed board has circuit devices having the desired frequency characteristic by changing the area and position of the earthed conductor, and circuit mounting parts having a signal processing circuit for processing signals (desired frequency characteristic) in the area that is different from the first area of dielectric substrate.

In accordance with the present invention, the conductive pattern is formed in inside layer in dielectric substrate to control distributed parameter circuit devices and patterns having one or plural rectangle-shaped areas without the earthed conductor, or the lattice-shaped earthed conductor formed in one or plural sides of outside of the dielectric substrate to change easily the area and position of the earthed conductor.

### BRIEF DESCRIPTIONS OF THE DRAWINGS

FIG. 1 shows a known band-pass filter;

FIG. 2 shows a known band-pass filter having tri-plate structure;

FIGS. 3A to 3C show the behavior of a known band-pass filter in odd exciting mode and even exciting mode;

FIG. 4 shows the distributed parameter circuit device;

FIGS. 5A and 5B show the behavior in odd exciting mode and even exciting mode;

FIGS. 6A to 6C show the structure of the band-pass filter 20;

FIG. 7 shows the frequency characteristic of the band-pass filter 20;

FIGS. 8A to 8B show the band-pass filter 30;

FIG. 9 shows the frequency characteristic of the band-pass filter 30;

FIGS. 10A and 10B show the band-pass filter 40;

FIG. 11 shows the frequency characteristic of the band-pass filter 40;

FIGS. 12A and 12B show another structure of the band-pass filter 20;

FIGS. 13A to 13C show the band-pass filter having the multi-layered structure;

FIG. 14 shows the printed board;

FIG. 15 is the oblique figure of the low-pass filter;

FIG. 16 is the oblique figure of the high-pass filter;

FIG. 17 is the oblique figure of the coupler;

FIG. 18 is the oblique figure of the directional coupler;

FIG. 19 is the superficial antenna; and

FIG. 20 is the oblique figure of the lumped parameter circuit device.

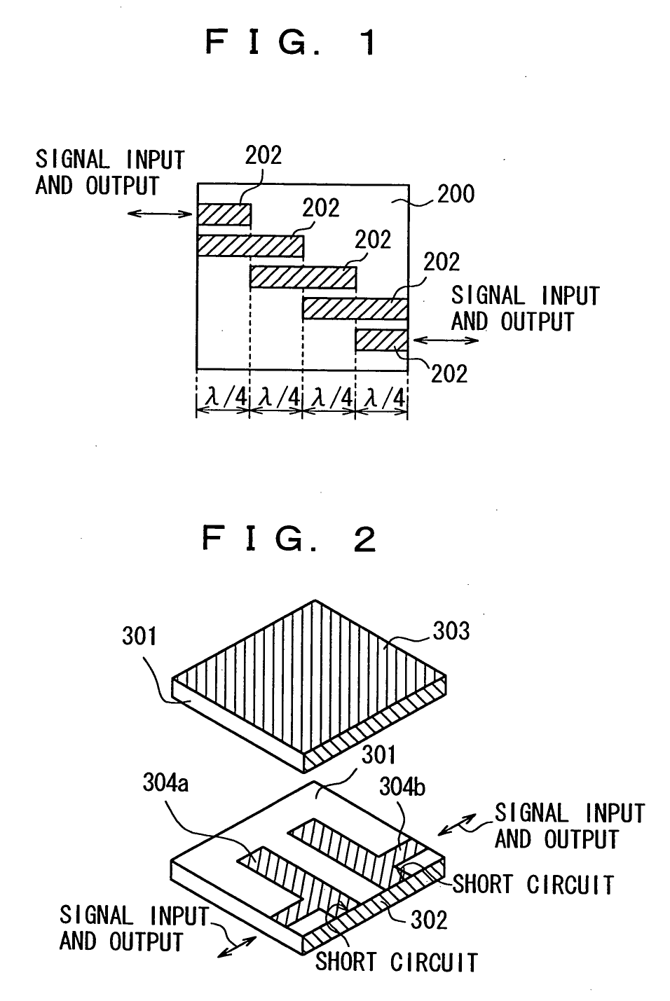

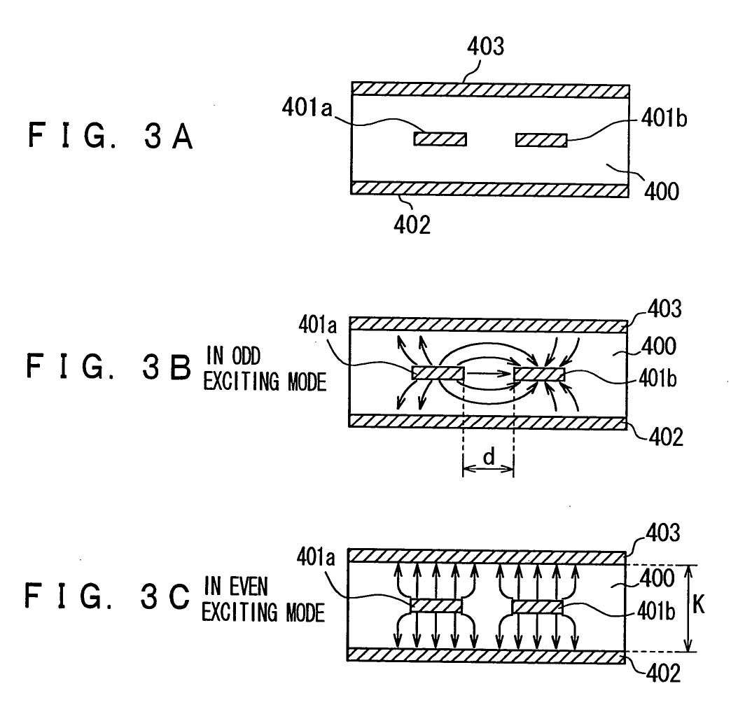

### DESCRIPTION OF THE PREFERRED EMBODIMENT

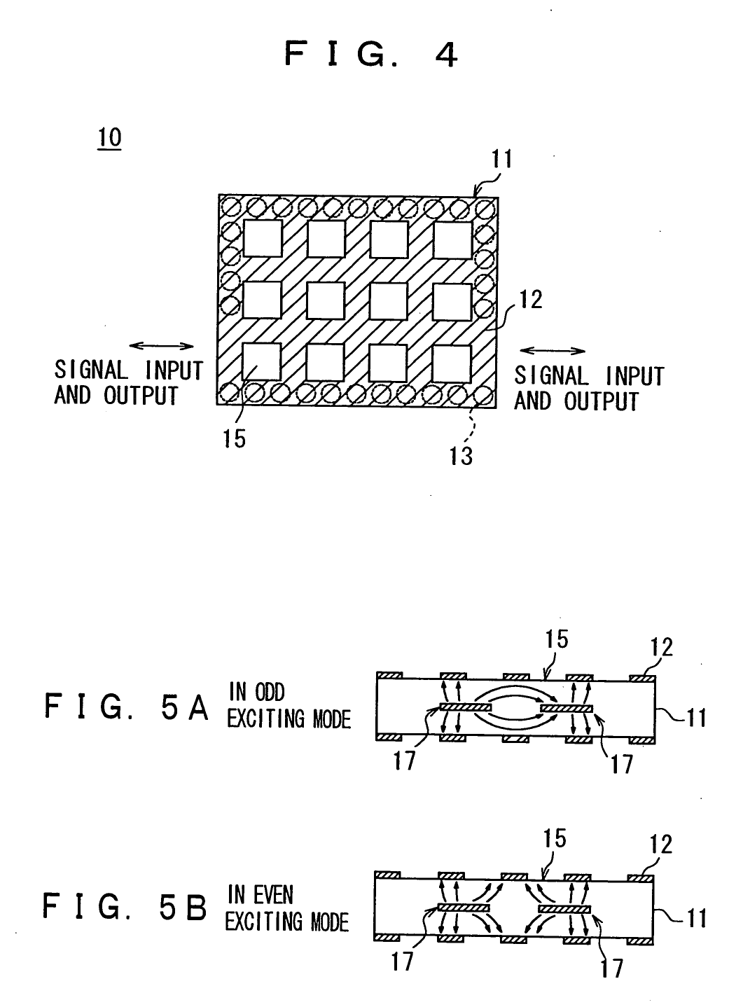

The embodiment of the present invention will become better understood with reference to the following description and drawings. Conductive patterns are formed on the substrate to control circuit devices, moreover, shown in FIG. 4 in the circuit device having earthed conductor which is formed on the dielectric substrate, e.g. the distributed parameter circuit device 10 having tri-plate structure, lattice-shaped earthed conductor 12 is formed on the dielectric substrate 11 to change the area and position of the earthed conductor. The earthed conductor 12 connects at layer via hole 13 with the earthed conductor (not illustrated) on the opposition side. Therefore, the conductive pattern, which control circuit device in the dielectric substrate, is shielded with earthed conductors and via hole.

When the pattern 12 which is formed the outside of the dielectric substrate forms the area 15 without the earthed conductor, shown in FIG. 5A in the odd exciting mode, shown in FIG. 5B in the even exciting mode, the frequency characteristic become be able to change because of changing the distribution of electromagnetic field between conductive patterns 17 and the earthed conductor that control actuation of circuit device. Therefore changing of the area and position of the earthed conductor can adjust the frequency characteristic of the distribution parameter circuit device having tri-plate structure to desired characteristic. For example, these measures are forming conductive parts on the area 15 without the earthed conductor, changing the position and amount of the conductive parts, and cutting earthed conductor between the areas without earthed conductor.

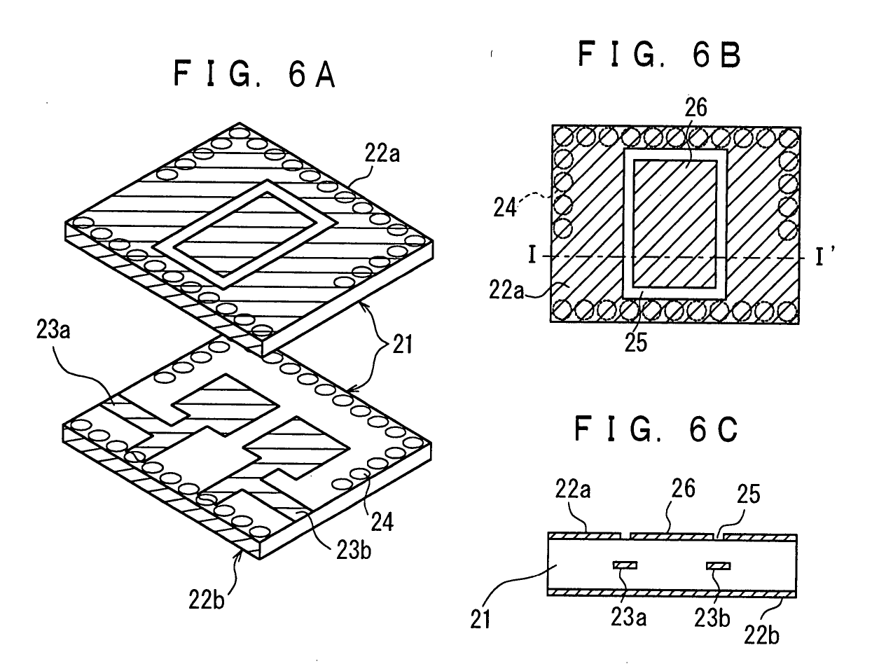

FIGS. 6A to 6C show the structure of the band-pass filter having tri-plate structure. This band-pass filter is impedance step type, that has the part of the pile of the adjacent resonator conductive pattern which has shorter length than λ/4.

FIG. 6A is an oblique figure, FIG. 6B is a plan and FIG. 6C is a sectional view at line I-I′ in FIG. 6B. Shown in FIGS. 6A to C, this band-pass filter has the earthed conductors 22a and 22b on both sides of the dielectric substrate (insulating substrate) 21. Moreover the band-pass filter has two resonator conductive patterns 23a and 23b between earthed conductors 22a and 22b to compose the band-pass filter. One edge of the resonator conductive patterns 23a and 23b are shortened with earthed conductors 22a and 22b by layer via hole 24. Expanding of the width of the pattern at the other edge (opening side) of the resonator conductive patterns 23a and 23b shortens the length of the pile of adjacent resonator conductive patterns by increasing the characteristic impedance at the short circuit side and decreasing the characteristic impedance at the opening side.

The earthed conductor 22a connects at said via hole 24 with 22b, and resonator conductive patterns 23 and 23b are shielded with forming layer via hole 24 in the circumference them.

For example, the pattern having the conductive layer 26 which is formed at opposite side of the resonator conductive patterns 23a and 23b, is formed on the earthed conductor 22a, said conductive layer 26 has the area 25 without the earthed conductor which is formed in the surroundings of it.

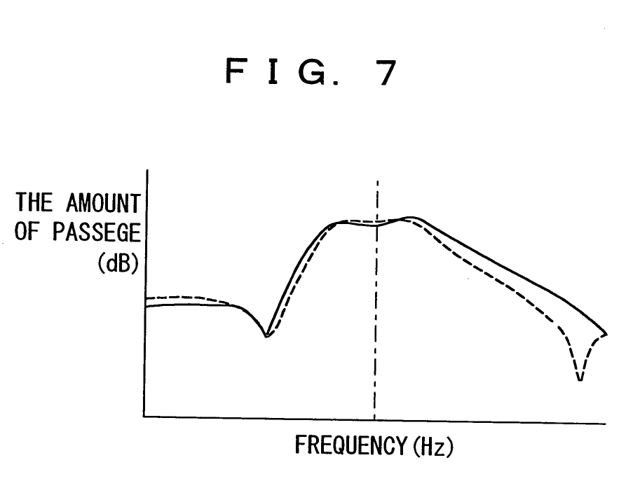

FIG. 7 shows the frequency characteristic of the band-pass filter 20 and, in this figure, the frequency characteristic (illustrated by solid line in FIG. 7) in the case of forming the conductive layer 26 having the area 25 without earthed conductor is enhanced in frequency band wider than that (illustrated by dotted line) in the case of deforming the area 25 without the earthed conductor.

Therefore designing resonator conductive pattern and dielectric substrate and forming the conductive layer 26 having the area 25 without the earthed conductor are provided desired frequency band having a desired frequency characteristic. When frequency characteristic is wider than desired frequency, you have only to form conductive parts e.g. copper foil, conductive paste and solder on the area 25 without earthed conductor so that frequency band will be narrow and you can obtain desired band-pass filter having a desired frequency characteristic. On the contrary, when the frequency characteristic is narrower than desired frequency band, you have only to cut the earthed conductor 2a and make the frequency band wide so that you can gain desired band-pass filter having a desired frequency characteristic.

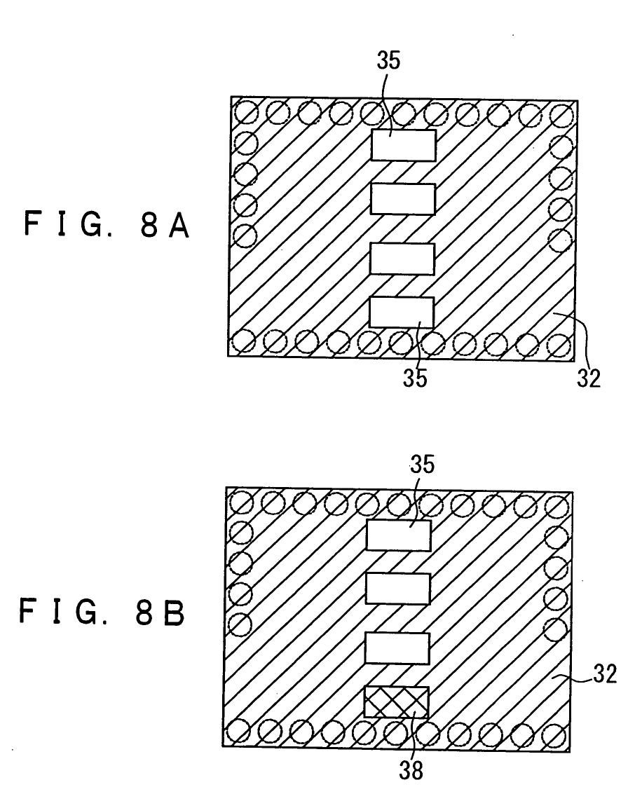

How to make the band-pass filter 30 which formed a pattern on the earthed conductor 32, said pattern is that rectangle-shaped non earthed conductive area 35 is formed on resonator conductive pattern or between resonator conductive patterns, as a method which made it change an area and a position of the earthed conductor is by forming the area without earthed conductor on the dielectric substrate, in shown FIG. 8A. In the case the area and position of the earthed conductor can change by forming the conductive parts 38 on rectangle-shaped area 35 without earthed conductor, in shown FIG. 8B.

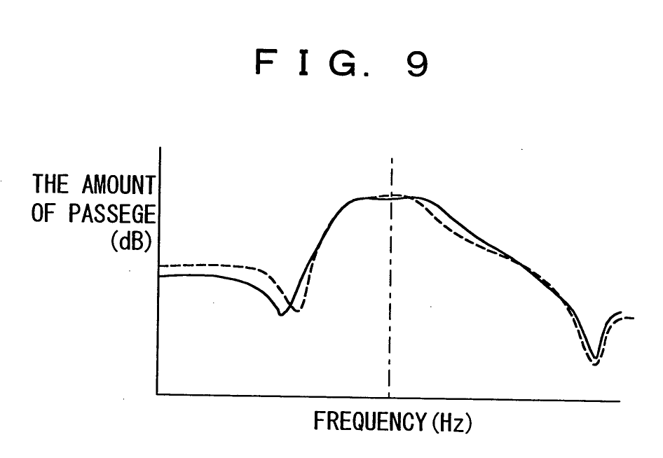

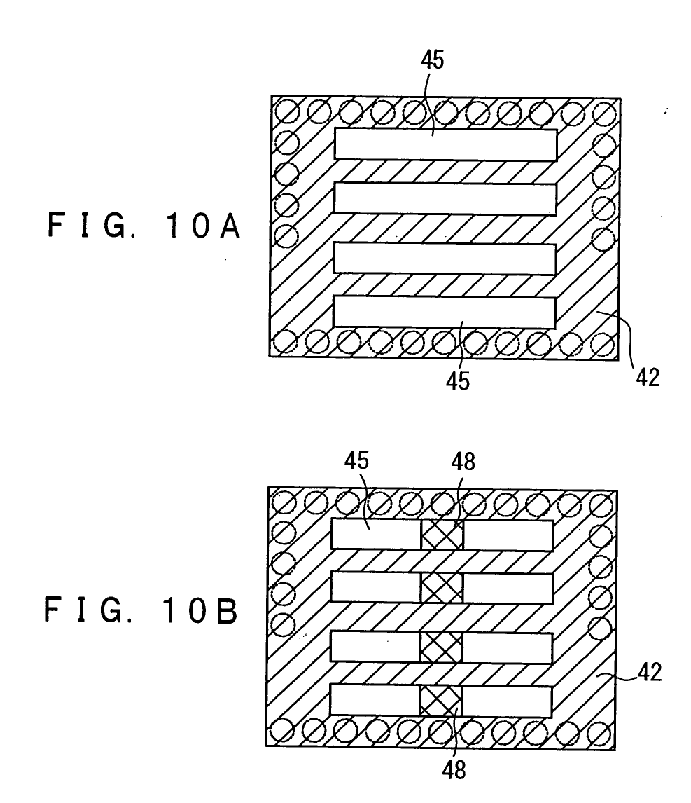

FIG. 9 shows the frequency characteristic of the band-pass filter 30, when the conductive parts 38 is formed on the rectangle-shaped area 35 without earthed conductor in the short circuit side, the frequency characteristic (solid line in FIG. 9) is wider toward high band side than the frequency characteristic (dotted line in FIG. 9) in the case of deforming conductive parts.

Therefore, forming the conductive parts 38 on the rectangle-shaped area 35 without earthed conductor, changing the position and amount of the conductive parts 38 or changing the area and position of earthed conductor by cutting earthed conductor, enable to obtain desired frequency characteristic. For example, when the frequency characteristic is narrower in high pass side than desired frequency band, you have only to form the conductive parts 38 on rectangle-shaped area 35 without earthed conductor and make the frequency band narrow in high pass side so that you can get the band-pass filter having desired frequency characteristic. On the contrary, when the frequency characteristic is wider in high pass side than desired frequency band, you have only to cut the earthed conductor 32 between rectangle-shaped areas 35 and make the frequency band wide in high pass side so that you can get the band-pass filter having desired frequency characteristic.

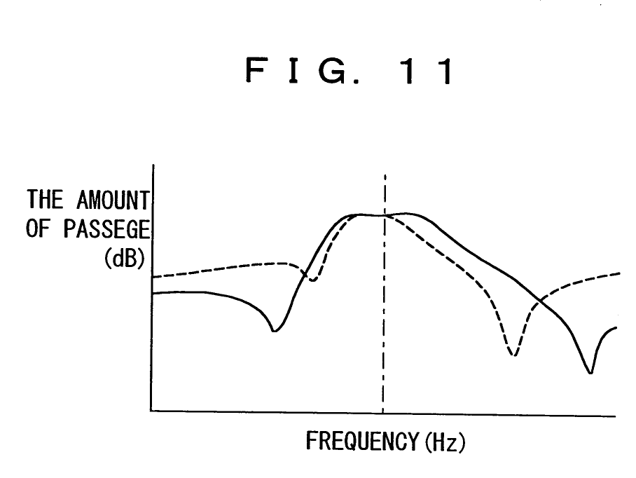

There is other method that the length in the signal input and output direction of the rectangle-shaped area 35 without earthed conductor, shown in FIGS. 8A and 8B, is lengthened to provide the band-pass filter 40 by forming the rectangle-shaped area 45 without the earthed conductor, shown in FIG. 10A. In the case, the frequency band (solid line in FIG. 11) in forming the conductive parts 48 on center of each of the rectangle-shaped area 45 without earthed conductor is wider than the frequency characteristic (dotted line in FIG. 11) in deforming the conductive parts 48, shown in FIG. 10B.

Therefore, forming the conductive parts 48 in the center of the rectangle-shaped area 45 without earthed conductor, changing the position of the conductive parts 48 or cutting the earthed conductor 42 to change the area and position of the earthed conductor, provide desired frequency characteristic. For example, when the frequency characteristic is narrower than desired, you have only to form the conductive parts 48 on rectangle-shaped area 45 without earthed conductor and make the frequency band wide so that you can get the band-pass filter having desired frequency characteristic. On the contrary, when the frequency characteristic is wider than desired frequency band, you have only to cut the earthed conductor 42 and make the frequency band narrow so that you can get the band-pass filter having desired frequency characteristic.

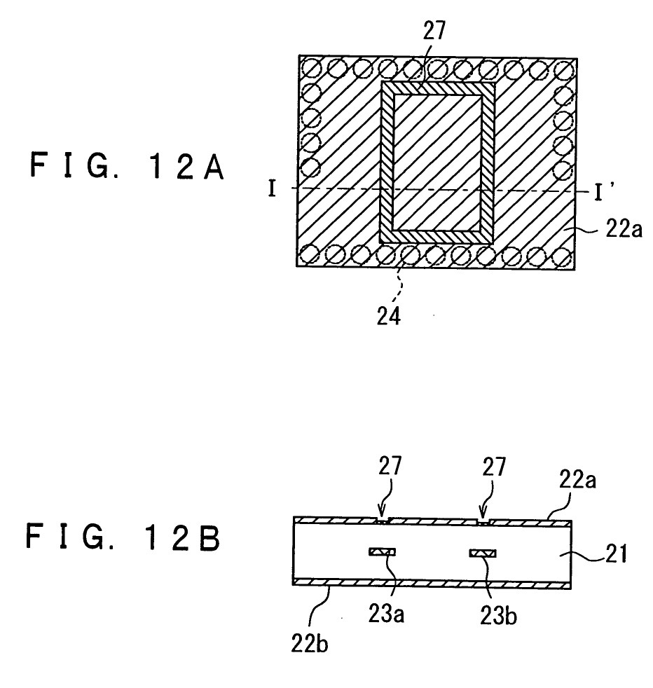

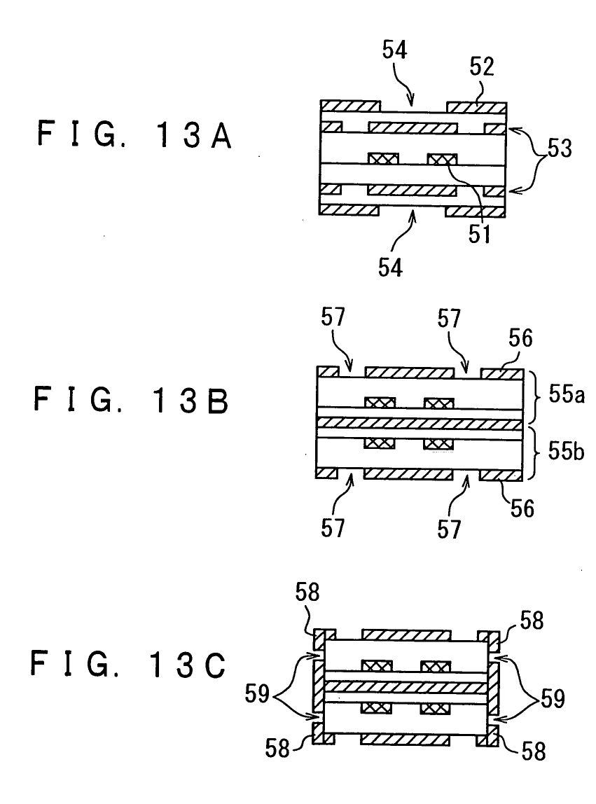

Moreover in the band-pass filter shown in FIGS. 6A to 6C, the area 25 without the earthed conductor exchanges for the thin-filmed conductive layer 27 shown in FIGS. 12A and 12B so that the thin-filmed conductive layer is cut and processed easily, you can adjust the frequency characteristic easily by changing the area and position of the earthed conductor.

In accordance with said embodiment, the area without earthed conductor is formed on one side of earthed conductor, of course you can form the area without earthed conductor on another side of the earthed conductor as same. In the case, you may form same patterns on both sides and form different patterns.

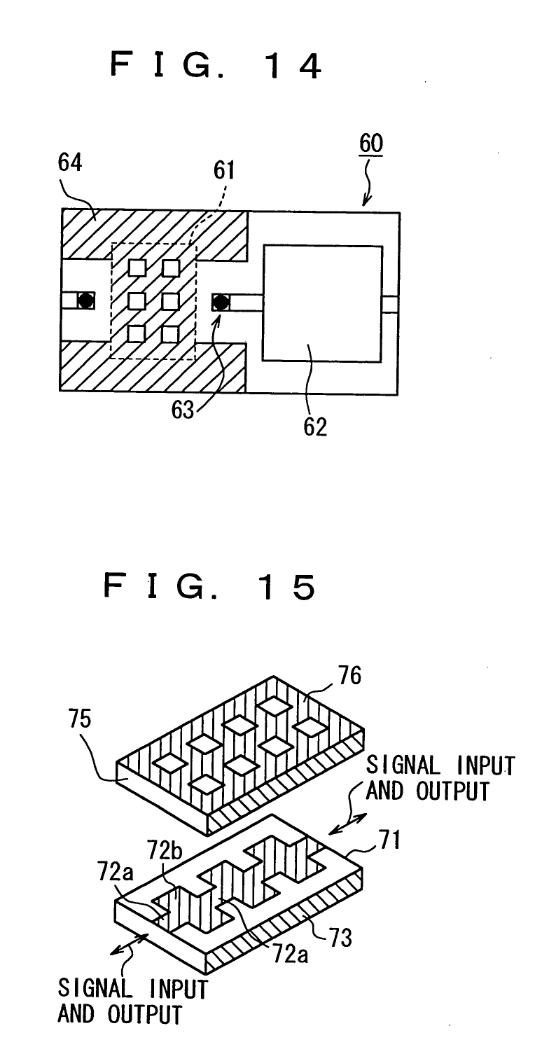

You can adjust the frequency characteristic by using said method, when the band-pass filter has multi-layered structure, shown in FIGS. 13A to 13C. Even if wiring pattern layer 53 is formed between resonator conductive pattern 51 and earthed conductor 52 as shown in FIG. 13A, it is able to change the characteristic of the band-pass filter by forming the area 54 without earthed conductor. But, in this case because of forming the wiring pattern layer 53 between resonator conductive pattern 51 and the earthed conductor 52, the amount of adjustment of the frequency characteristic is less than the amount of adjustment of the frequency in non multi-layered structure. When two band-pass filters 55a and 55b have laminated structure having unified earthed conductor 56, you can adjust the frequency characteristic by forming the area 57 without the earthed conductor on outside layer which changes corresponding to the frequency characteristic of the band-pass filter and changing the area and position of the earthed conductor, shown in FIG. 13B. Moreover, if the distance of the side of substrate having band-pass filter and resonator conductive pattern is short, forming the earthed conductor 58 on side surface and forming the area 59 without the earthed conductor on side surface of the substrate and changing the area and position of the earthed conductor is enable the frequency characteristic to change, shown in FIG. 13C.

The above-mentioned description about said embodiment explains about the distributed parameter circuit device as the band-pass filter. When the printed board 60 which makes enable signal processing circuit 62, e.g. MMIC, to mount on the substrate having the distributed parameter circuit device 61, it is possible to change the area and position of the earthed conductor corresponding to the position of conductive pattern for setting up the distributed parameter circuit 61 device connecting at connecting via hole 63 with signal processing circuit by forming pattern on the earthed conductor 64, shown in FIG. 14.

In accordance with said embodiment, forming the resonator pattern as the distributed parameter circuit device composes the band-pass filter, you can compose the low-pass filter and high-pass filter by changing the pattern.

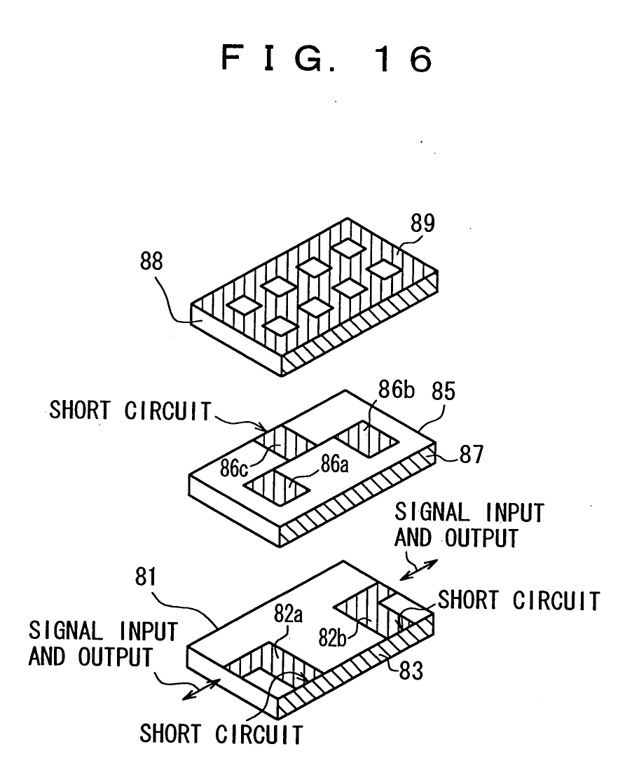

FIG. 15 is the oblique figure of the low-pass filter 70. The pattern 72a for the series inductance and the pattern 72b for the parallel capacity are formed in series and in turns on one side of the dielectric substrate 71. Moreover, the earthed conductor 73 is formed on another side of the substrate. Plastering the dielectric substrate 71 formed the patterns 72a and 72b to the dielectric substrate 75 formed the earthed conductor 76 forms the band-pass filter 70 having the tri-plate structure. Changing the area and position of the earthed conductor by forming the area without the earthed conductor on side formed the earthed conductor provides desired frequency characteristic, as the band-pass filter.

FIG. 16 is the oblique figure of the high-pass filter. The patterns 82a and 82b for the parallel inductance are formed on one side of the dielectric substrate 81 and the earthed conductor 83 is formed on another side of the dielectric substrate 81. The edges of the patterns 82a and 82b are shorted with the earthed conductor 83. Producing the series capacity opposite to the patterns 82a and 82b and connecting the patterns with the earthed conductor form the patterns 86a and 86b and 86c for the parallel inductance on one side of the dielectric substrate 85. The earthed conductor is formed on the side that is not signal input and output side. Moreover, the earthed conductor is formed on one side of the dielectric 89 substrate 88.

The dielectric substrate 85 plasters to the patterns 82a and 82b on the dielectric substrate 81 and the dielectric substrates 88 plasters to the pattern 86 on the dielectric substrate 85. When the dielectric substrate 81 plasters to the dielectric substrate 85, the dielectric substrate 85 interpose between the patterns 82a and 82b and the patterns 86a and 86b. When the dielectric substrate 85 plasters to the dielectric substrate 88, the dielectric substrate 88 interpose between the pattern 86 and the earthed conductor 89. In this case the dielectric substrate 81 plasters to the dielectric substrate 85, and the dielectric substrate 85 plasters to the dielectric substrate 88, at the same time, the earthed conductor 83 connect with earthed conductor 87 and the earthed conductor 87 connects with the earthed conductor 89 so that it forms the high-pass filter having tri-plate structure. In this case, changing the area and position of the earthed conductor by forming the area without the earthed conductor on side formed the earthed conductor 89 provides the desired frequency characteristic.

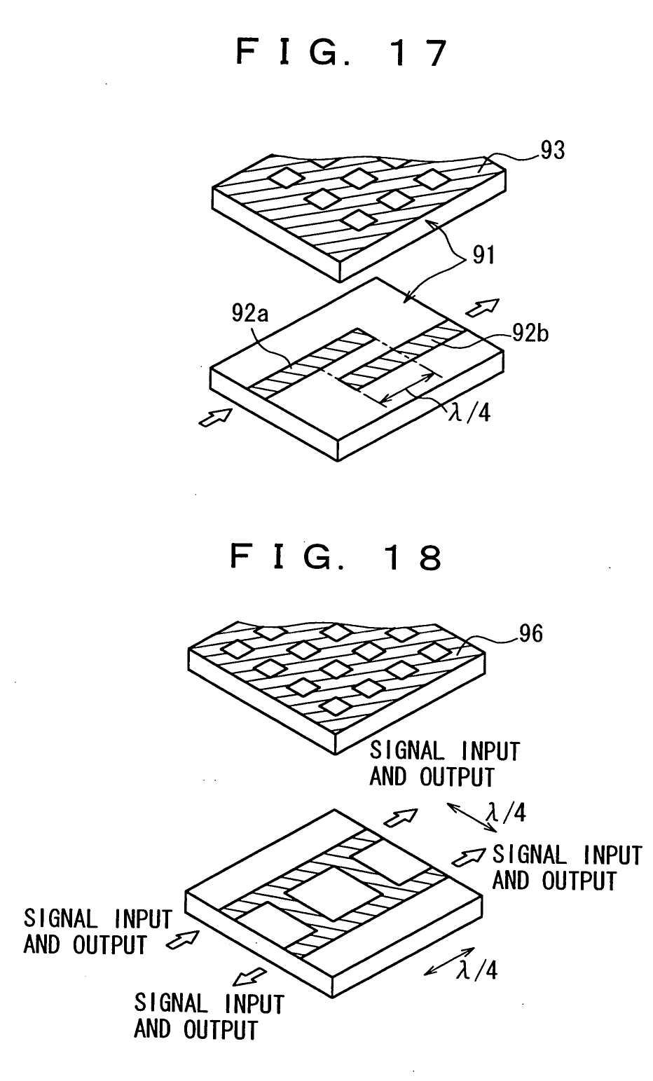

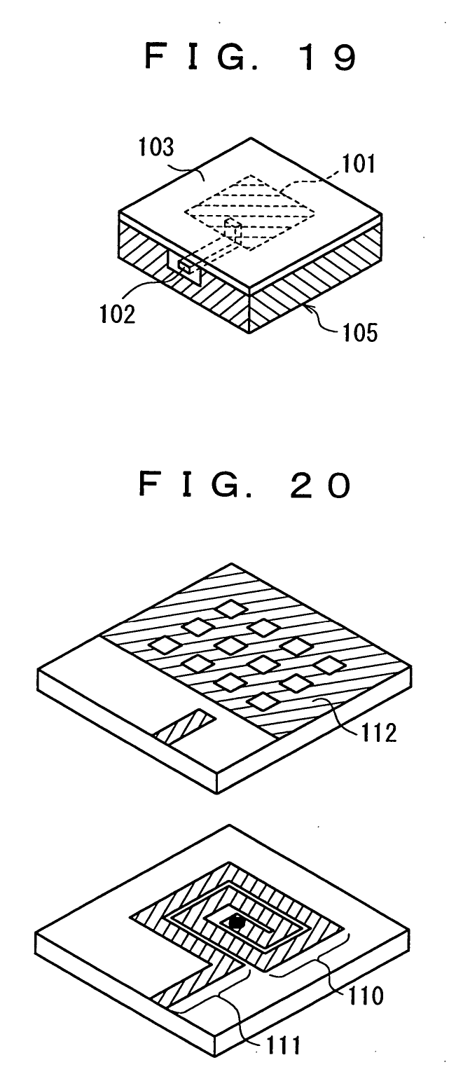

Moreover, the present circuit device is not limited to the distributed circuit device. In adjustment of characteristics of the coupler, antenna and the combination between layers of the distributed parameter device, changing the area and position of the earthed conductor provides the desired frequency characteristic. FIG. 17 is the oblique figure of the coupler 90, which cuts a direct correct portion. The coupler has the part of the pile of the length about ¼ λ of the conductive pattern 92a formed on the dielectric substrate 91 and the conductive pattern 92b formed on the substrate 91. If the area and position of the earthed conductor 93 formed outside of conductive patterns 92a and 92b become to change easily, you can get the desired coupler. FIG. 18 is the oblique figure of the directional coupler 95, in same way, if the area and position of the earthed conductor 96 formed outside become to change easily, you can get the desired directional coupler. FIG. 19 shows superficial antenna. The patch 101 for receiving and transmitting of the electric wave connects with the electric supply line 102. When the protective layer 104 si formed on the side formed the patch 101 is formed, if the area and position of the earthed conductor 105 on backside becomes to change easily you can get the desired superficial antenna. FIG. 20 is the oblique figure the lumped parameter circuit device having the condenser and coil formed by conductive pattern. For example, changing the area and position of the earthed conductor 112 which is formed opposite to the coil 110 to change the capacity of the coil 110 and the earthed conductor 112, provides the desired characteristic.

Lattice-shaped earthed conductors are formed in FIG. 14˜FIG. 20, of course, it is possible to form the earthed conductor as shown in FIGS. 6A to 6C, FIGS. 8A, 8B and FIGS. 10A, 10B. Moreover, if the pattern enables the area and position of the earthed conductor to change easily, it is not limited to said shape.

In accordance with the present invention, changing the area and position of the earthed conductor by forming conductive pattern in inside layer of the dielectric substrate and forming the earthed conductor in outside layer of the dielectric substrate, provides the desired frequency characteristic. Therefore, even if it is impossible to change the form of the conductive pattern of the inside layer because of laminated substructure, you can get the desired frequency characteristic. Moreover, even if the material accuracy and processing accuracy are not managed strictly, you have only to change the area and position of the earthed conductor, and you can adjust the frequency characteristic with precision.

In addition, because of forming the pattern, which can change the area and position on the earthed conductor, it is possible to get easily the desired frequency characteristic by using the pattern. In the case pattern is formed on one side or plural sides of the dielectric substrate, the adjustment range of the frequency characteristic can be expanded and the adjustment precision can be enhanced by forming same or difference pattern.

In the circuit device, having the conductive pattern which formed on inside layer of the first area of the dielectric substrate and the earthed conductor which formed on outsid are of the first area of the dielectric substrate, setting up the frequency characteristic using the conductive pattern and changing the area and position of the desired frequency characteristic of the earthed conductor provide the desired frequency characteristic. Moreover, it is possible to process the signal without noise or the influence of signal transmission lines by using the printed board having the circuit mounting part which has the signal processing circuit that is formed on the area which is different from the circuit device parts and the first area of the dielectric substrate, said the signal processing circuit processes the desired frequency characteristic signal.

1. A circuit device comprising, a conductive pattern, which is formed in inside layer of a dielectric substrate, an earthed conductor, which is formed in outside layer of said dielectric substrate, and said conductive pattern determines the frequency characteristic, and changing the area and position of said earthed conductor provides the desired frequency characteristic, wherein the earthed conductor is connected with the conductive pattern.

2. A circuit device as claimed in claim 1, comprising a pattern formed on said earthed conductor, and that enables to change the area and position of the earthed conductor.

3. A circuit device as claimed in claim 2, comprising said pattern, which formed one side, or plural sides of outside layer of said dielectric substrate.

4. A circuit device as claimed in claim 3, comprising a same or different pattern, which is formed one side, or plural sides of outside layer of said dielectric substrate.

5. A circuit device as claimed in claim 2, comprising a said pattern having a lattice shaped said earthed conductor.

6. A circuit device as claimed in claim 2, comprising a said pattern forming one rectangle-shaped and not earthed conductor area or plural areas on said earthed conductor.

7. A circuit device as claimed in claim 2, where in said pattern is thinner than said earthed conductor and forms a non earthed conductor area in cutting it.

8. A printed board comprising, a circuit device part having a conductive pattern which is formed in inside layer of the first area of a dielectric substrate, an earthed conductor which is formed in outside layer of the first area of said dielectric substrate, where in said circuit device part provides desired frequency characteristic by setting up the frequency characteristic by said conductive pattern and changing the area and position of said earthed conductor, a mounted circuit part having a signal processing circuit for processing a desired frequency characteristic signal, which formed on different, the first area of said dielectric substrate, wherein the earthed conductor is connected with the conductive pattern.

9. A circuit device, comprising:
a dielectric substrate
at least one conductive pattern formed in the dielectric substrate;
a first earthed conductor formed on a first surface of the dielectric substrate, wherein the first earthed conductor does not cover the entire area of the first surface; and
a second earthed conductor formed on a second surface of the dielectric substrate, the second surface opposed to the first surface, wherein the first earthed conductor is connected with the second earthed conductor, wherein the earthed conductor is connected with the conductive pattern.

10. The circuit device according to claim 9, wherein the area of the earthed conductor is changeable on the second area to achieve a desired frequency characteristic.

11. The circuit device according to claim 9, wherein the first area is an inside layer of the dielectric substrate.

12. The circuit device according to claim 9, wherein the second area is on the outside of the dielectric substrate.

13. The circuit device according to claim 9, wherein each earthed conductor are positioned in a spaced relation on the second area.

14. The circuit device according to claim 13, wherein the spaced relation is lattice shaped.

15. A printed board, comprising:
a circuit device positioned on the circuit board;
a dielectric substrate, the dielectric substrate having a first area and a second area;
a conductive pattern formed in the first area;
an earthed conductor formed on the second area wherein the position of each earthed conductor is changeable on the second area to achieve a desired frequency characteristic; and
a mounted circuit part having a signal processing circuit for processing the desired frequency characteristic signal, wherein the earthed conductor is connected with the conductive pattern.

16. The circuit device according to claim 15, wherein the area of the earthed conductor is changeable on the second area to achieve a desired frequency characteristic.

17. The circuit device according to claim 15, wherein the first layer is an inside layer of the dielectric substrate.

18. The circuit device according to claim 15, wherein the second layer is an outside of the dielectric substrate.

19. The circuit device according to claim 15, wherein each earthed conductor are positioned in a spaced relation on the second area.

20. The circuit device according to claim 19, wherein the spaced relation is lattice shaped.

21. A method of forming a circuit device, comprising:
forming a conductive pattern within a dielectric substrate;
forming an earthed conductive pattern on the outside of the dielectric substrate; and
adjusting the frequency characteristic of the circuit device by changing the area and position of the earthed conductor pattern which changes the distribution of the electromagnetic field between the conductive pattern and the earthed conductor pattern, wherein the earthed conductor is connected with the conductive pattern.

22. The method of forming a circuit device according to claim 21, further comprising connecting the earthed conductor pattern by via holes.

23. A method of forming a circuit device according to claim 21, further comprising shortening a length of a pile of the conductive pattern by expanding the width of the pattern of the conductive pattern.

24. A method of forming a circuit device according to claim 21, further comprising forming the earthed conductive pattern in a lattice shape, the lattice shape having open areas without the earthed conductor pattern.

25. A method of forming a circuit device according to claim 24, further comprising narrowing the frequency characteristic by forming conductive parts on the open areas.

26. A method of forming a circuit device according to claim 21, further comprising widening the frequency characteristic by removing portions of the earthed conductor pattern.

27. A method of forming a circuit device according to claim 21, wherein the conductive pattern is formed inside the dielectric substrate.

28. A method of forming a circuit device according to claim 21, wherein the earthed conductor pattern is formed on the outside of the substrate.

29. A circuit device, comprising:
a dielectric substrate
at least one conductive pattern formed in the dielectric substrate;
a first earthed conductor formed on a first surface of the dielectric substrate, wherein the first earthed conductor does not cover the entire area of the first surface; and
a second earthed conductor formed on a second surface of the dielectric substrate, the second surface opposed to the first surface, wherein the first earthed conductor is connected with the second earthed conductor only along the periphery of the dielectric substrate, wherein the earthed conductor is connected with the conductive pattern.

30. A circuit device as claimed in claim 29, comprising at least one of the earthed conductors is formed as a pattern that has portions that are removed.

31. A circuit device as claimed in claim 30, comprising said pattern, which is formed on one side, or plural sides of outside layer of said dielectric substrate.

32. A circuit device as claimed in claim 31, comprising a same or different pattern, which is formed one side, or plural sides of outside layer of said dielectric substrate.

33. A circuit device as claimed in claim 30, comprising a said pattern having a lattice shaped said earthed conductor.
